(19) United States
(12) Patent Application Publication
(10) Pub. No.: US 2010/0043417 A1
(43) Pub. Date: Feb. 25, 2010

(54) METHOD FOR DETERMINING A SETTING PARAMETER FOR A HYDROSTATIC DISPLACEMENT UNIT AND A CORRESPONDING SYSTEM

(76) Inventors: Matthias Mueller, Neusaess (DE); Sebastian Oschmann, Strass (DE)

Correspondence Address: Muncy, Geissler, Olds & Lowe, PLLC, P.O. BOX 1364, FAIRFAX, VA, 22038-1364, US

(21) Appl. No.: 12/543,891

(22) Filed: Aug. 19, 2009

(30) Foreign Application Priority Data
Aug. 20, 2008 (DE) 10 2008 038 436.4

(51) Int. Cl. B60K 6/12

(52) U.S. Cl. 60/327; 60/329

(57) ABSTRACT

A method and a system for determining a setting parameter of a hydrostatic displacement unit is provided. In the method, a pressure value, a rotational speed value, and a torque value are determined. The setting parameter can be determined with use of the pressure value, rotational speed value, torque value of the setting parameter characteristic diagram, and a setting parameter characteristic diagram, which is an inverted efficiency characteristic diagram, which has at least pressure, rotational speed, and torque as input parameters. The system can include a system unit for determining a pressure value, a system unit for determining a rotational speed value, a system unit for determining a torque value, and a system unit for determining the setting parameter with use of the pressure value, rotational speed value, torque value, and a characteristic diagram, whereby the system for determining a setting parameter is formed so that during the determination of the setting parameter it can use as a characteristic diagram a setting parameter characteristic diagram, which is an inverted efficiency characteristic diagram or torque characteristic diagram, which has at least pressure, rotational speed, and torque as input parameters.

This nonprovisional application claims priority under 35 U.S.C. §119(a) to German Patent Application No. 10 2008 038 436.4, which was filed in Germany on Aug. 20, 2008, and which is herein incorporated by reference.

### BACKGROUND OF THE INVENTION

1. Field of the Invention

The present invention relates to a method for determining a setting parameter of a hydrostatic displacement unit and a corresponding system, particularly for hydrostatic traction drives.

2. Description of the Background Art

WO 2006/017901 A1 discloses a determination of a pivoting angle for a hydrostatic displacement unit with the aid of a preset target torque, an existing pressure value, and an existing rotational speed value. An algorithm and a family of characteristic diagrams are used for this purpose. Each characteristic diagram of the family of characteristic diagrams represents the dependence of the torque on the pressure and rotational speed for a pivoting angle as a parameter. The family of characteristic diagrams in its entirety therefore represents the dependence of the torque on the pressure and rotational speed for different pivoting angles as parameters. Each characteristic diagram is stored in discrete form, i.e., in the form of a discrete list. For a target torque predefined for a specific time, the rotational speed existing at this time and the pressure prevailing at this time are determined. In each characteristic diagram assigned to one of various pivoting angles, the two rotational speeds nearest the actual rotational speed (n1(θ), n2(θ)) and the two pressures nearest the actual prevailing pressure (p1(θ), p2(θ)) are determined. From the nearest two rotational speeds (n1(θ), n2(θ)) and the nearest two pressures (p1(θ), p2(θ)), the four different combinations (n1(θ), p1(θ)), (n1(θ), p2(θ)), (n2(θ), p1(θ)), and (n2(θ), p2(θ)) and the torque values assigned to them in this sequence d1(θ), d2(θ), d3(θ), and d4(θ) are assigned. A diagram-specific result torque d(θ) is determined by means of linear interpolation from the four assigned torque values d1(θ), d2(θ), d3(θ), and d4(θ). Then the two result torques d(θ₁) and d(θ₂) coming closest to the target torque d_{S} are determined. A target pivoting angle θ′ between θ₁ and θ₂ is determined by means of linear interpolation from the two result torques d(θ₁) and d(θ₂). This pivoting angle is sent to the control device. Therefore, pivoting angle-specific torques are sought for each target torque for each pivoting angle, pivoting angle-specific result torques are calculated from the sought pivoting angle-specific torques by means of linear interpolation, the most favorable is sought from the pivoting angle-specific result torques, and a target pivoting angle is calculated from the sought favorable pivoting angle-specific result torques by means of further linear interpolation.

This method has the disadvantage that each sought target pivoting angle must be calculated again with use of several and particularly also unnecessary search procedures and linear interpolation procedures. The method therefore is highly complex and costly. For example, it is unnecessary to search for the torques d1(θ), d2(θ), d3(θ), and d4(θ) for irrelevant pivoting angles θ or pivoting angle ranges and to calculate an irrelevant result torque d(θ) from these torques. As a result, the computational effort and the time expenditure for determining a target pivoting angle θ′ for a target torque d_{S} are greatly increased. After the result torques d(θᵢ) are determined, an additional further search procedure and a subsequent further linear interpolation method are carried out. As a result, the computational effort and the time expenditure for determining a target pivoting angle θ′ for the target torque d_{S} are increased even more.

### SUMMARY OF THE INVENTION

It is therefore an object of the present invention to provide a method and a system for determining a setting parameter of a hydrostatic displacement unit, which are simple and with which the setting parameter can be determined merely with low computational effort and time expenditure.

The system according to an embodiment of the invention for determining a setting parameter of a hydrostatic displacement unit can comprise a system unit for determining a pressure value, a system unit for determining a rotational speed value, a system unit for determining a torque value, and a system unit for determining the setting parameter using the pressure value, the rotational speed value, the torque value, and a characteristic diagram. The system for determining a setting parameter is thereby formed so that during the determination of the setting parameter, a setting parameter characteristic diagram can be used as a characteristic diagram which is an inverted efficiency characteristic diagram, which has at least pressure, rotational speed, and torque as input parameters. The individual system units together form a control device of a hydrostatic system, e.g., a hydrostatic traction drive.

Using the system of the invention, the advantageous method of the invention can be carried out to determine a setting parameter of a hydrostatic displacement unit. The setting parameter in the axial piston machines to be used preferably in a swash plate design is the pivoting angle of the swash plate. This application to other adjustable hydrostatic piston machines is possible, of course. The method of the invention comprises a determination of a pressure value, a determination of a rotational speed value, a determination of a torque value, and a determination of the setting parameter with use of the pressure value, the rotational speed value, the torque value, and a characteristic diagram. The method is particularly notable in that the used characteristic diagram is a setting parameter characteristic diagram, which is an inverted efficiency characteristic diagram, which has at least pressure, rotational speed, and torque as input parameters.

Because the used characteristic diagram is a setting parameter characteristic diagram, which is an inverted efficiency characteristic diagram, which has at least pressure, rotational speed, and torque as input parameters, the determination of an optimal setting parameter is simplified. In particular, the method saves computational effort and computing time. For example, a pivoting angle or a pivoting angle value of a hydrostatic displacement unit or a control signal for setting such a pivoting angle can be determined as a setting parameter. The determination of the optimal setting parameter can be carried out by searching for or calculating the setting parameter. The search for the setting parameter can be carried out in a setting parameter characteristic diagram stored as a table.

The calculation of the setting parameter can be carried out using a setting parameter characteristic diagram stored as a function. Because the setting parameter characteristic diagram is an inverted efficiency characteristic diagram, which has at least pressure, rotational speed, and torque as input parameters, a simplified and advantageously rapid search or a simplified and advantageously rapid calculation of the optimal setting parameter is made possible. A repeated characteristic diagram inversion during each determination of an optimal setting parameter is avoided by the use of an inverted characteristic diagram. The setting parameter can be determined, i.e., searched for or calculated, by the use of an inverted characteristic diagram, which has at least pressure, rotational speed, and torque as input parameters or independent variables and the setting parameter as the output parameter or dependent variable, directly and without unnecessary additional searching and computation from a determined pressure value, a determined rotational speed value, and a determined torque value and with the inverted diagram. The method is simplified and saves time and effort.

The system for determining a setting parameter can be formed so that the setting parameter characteristic diagram can be calculated off-line by it before the determination of the setting parameter. As a result, the setting parameter characteristic diagram can be calculated off-line before the determination of the setting parameter. The setting parameter characteristic diagram formed as an inverted efficiency characteristic diagram or torque characteristic diagram is then available even before the determination of an optimal setting parameter for the determination of an optimal setting parameter. The later on-line determination of the optimal setting parameter is therefore accelerated.

The system for determining a setting parameter can be formed so that the setting parameter characteristic diagram can be stored by it in a memory off-line before the determination of the setting parameter. As a result, the setting parameter characteristic diagram can be stored in a memory off-line before the determination of the setting parameter. As a result, the setting parameter characteristic diagram need not be calculated anew or determined in each determination of an optimal setting parameter. The setting parameter characteristic diagram therefore also does not need to be calculated anew before each turning on of the system. As a result, the computational effort for calculating the setting parameter characteristic diagram per determination of an optimal setting parameter is reduced further in the long-term. Moreover, waiting periods for off-line calculations can be avoided. The determination of the optimal setting parameter is thereby simplified overall and accelerated.

In an embodiment, the system for determining a setting parameter can be formed so that the setting parameter characteristic diagram is stored in a memory at least in part as a value table. The setting parameter characteristic diagram is stored in the memory for this purpose in an exemplary embodiment before the determination of the setting parameter at least in part as a value table. The value table allows simple searching for an optimal setting parameter.

The system for determining a setting parameter can be formed so that the setting parameter characteristic diagram is stored in a memory at least in part as a function table. The setting parameter characteristic diagram is stored in the memory for this purpose in an exemplary embodiment before the determination of the setting parameter at least in part as a function table. The table may contain one or more functions and therefore also a family of functions. A table function can depend on one or more parameters from the parameter group including: pressure, rotational speed, and/or torque. As a result, a table function can be assigned one or more parameter values on which it does not depend. For example, pressure values, rotational speed values, and/or torque values can be used as parameter values. To determine an optimal setting parameter, a table function is searched for according to a determined pressure value, rotational speed value, and/or torque value. On the basis of the selected table function and the other parameter value(s), the optimal setting parameter is then calculated. Each selectable table function can be calculated thereby by linear interpolation from a setting parameter characteristic diagram, described above as a value table. The use of one or more table functions allows highly accurate calculation of an optimal setting parameter. The setting parameter characteristic diagram can also be available or become stored or be stored in part as value tables or in part as function tables.

The system for determining a setting parameter can be formed so that the pressure value and/or the rotational speed value can be determined in each case from at least one measurement. As a result, the pressure value and/or the rotational speed value in each case can be determined from at least one measurement. In this way, a realistic optimal setting parameter, corresponding to a current real operational state, can be determined.

The system for determining a setting parameter can be formed so that the system unit can be used for determining a torque value by a user. As a result, the torque value, which is a target torque value, can be predefined by a user command.

Thus, by the method of the invention and by the system of the invention, a realistic optimal setting parameter can be determined simply and in a time-saving manner, which corresponds to a target specification by a user and a real current operational state. “Current” here can mean: at the time of the target specification.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic depiction of a preferred exemplary embodiment of the system of the invention;

FIG. 2 shows a flowchart of a preferred exemplary embodiment of the method of the invention; and

FIG. 3 shows an example of a depiction of a three-dimensional inverted characteristic diagram as a setting parameter characteristic diagram.

### DETAILED DESCRIPTION

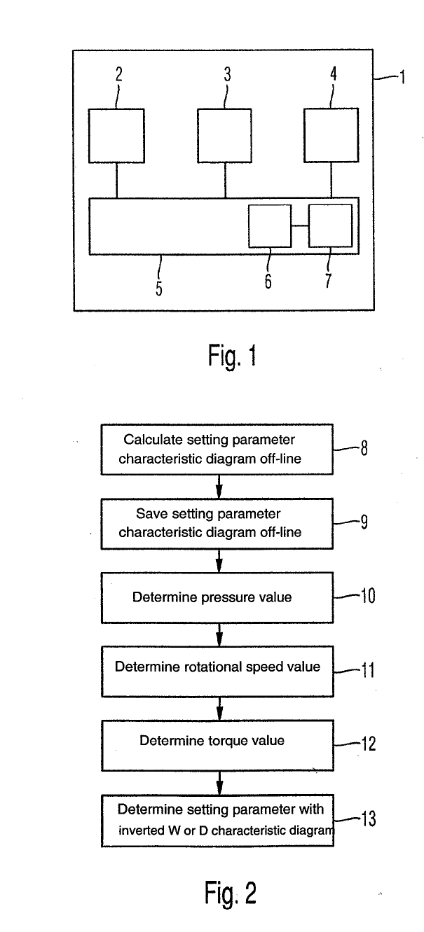

A schematic depiction of an exemplary embodiment of the system of the invention is shown in FIG. 1. The depicted system 1 of the invention for determining a setting parameter of a hydrostatic displacement unit comprises a first system unit 2 for determining a pressure value, a second system unit 3 for determining a rotational speed value, a third system unit 4 for determining a torque value, and a fourth system unit 5 for determining the setting parameter using the pressure value, the rotational speed value, the torque value, and a characteristic diagram. The fourth system unit 5 in this case comprises an arithmetic logic unit 6 for calculating, e.g., functions, table functions, or optimal setting parameters and a memory 7 for storing, e.g., table functions, parameter values, parameter value sets, characteristic diagrams, inverted characteristic diagrams, dependent variables, and independent variables in lists or alone, etc. All system units in this case are interconnected, so that they can communicate with one another and thus exchange data and/or commands. The system units are preferably arranged in a single control device. A distributed system, in which several control devices are linked with one another, is also possible, however.

FIG. 2 shows a flowchart of a preferred exemplary embodiment of the method of the invention for determining a setting parameter of the hydrostatic displacement unit. The depicted method of the invention comprises a first process step 8, in which the setting parameter characteristic diagram (therefore before the determination of the setting parameter) is calculated off-line, and a second process step 9, in which the setting parameter characteristic diagram (before the determination of the setting parameter) is stored off-line in a memory of system 1. Moreover, the depicted method of the invention comprises a third process step 10, in which a pressure value is determined, a fourth process step 11, in which a rotational speed value is determined, and a fifth process step 12 in which a torque value is determined. In a later sixth process step 13, the setting parameter is determined with use of the pressure value, the rotational speed value, the torque value, and a characteristic diagram.

In the first process step 8, in which the setting parameter characteristic diagram is calculated off-line, the setting parameter characteristic diagram is created as an inverted efficiency characteristic diagram or torque characteristic diagram, which has at least pressure, rotational speed, and torque as input parameters or independent variables and the setting parameter as the output parameter or dependent variable. The setting parameter characteristic diagram in this case is generated from a non-inverted efficiency characteristic diagram or torque characteristic diagram, which has at least pressure, rotational speed, and the setting parameter as input parameters or independent variables and an efficiency or torque as the output parameter or dependent variable. The setting parameter in the shown exemplary embodiment is an absolute or relative pivoting angle, an absolute or relative pivoting angle value, or a pivoting angle control signal. The off-line calculation is explained in still greater detail hereinafter.

In the second process step 9, in which the setting parameter characteristic diagram is stored off-line in a memory, the setting parameter characteristic diagram is stored at least in part as a value table and/or at least in part as a function table. The setting parameter characteristic diagram contains information on the dependence of the setting parameter on the other listed parameters. This information can be presented in different ways.

A first representation form is a value table or a value matrix, in which, e.g., in columns or rows in each case dependent or independent variables are listed as such, whereby the rows or columns represent associated value tuples, which in their entirety in turn represent the setting parameter characteristic diagram.

A second representation form is a function table or a function vector or a function matrix. In a function vector, the column or row index represents a parameter (e.g., pressure value, rotational speed value, torque value), which identifies an individual function. In a function matrix, the column and row index together represent a parameter pair, which identify an individual function. In general, parameter-n-tuples can be used to identify individual functions. Here, it holds that each identifying parameter replaces and eliminates an independent variable. The functions can be simplified by this replacement or elimination. In an exemplary embodiment, there is only one function, which depends on all free parameters or independent variables, in the function table. By reducing the number of functions and increasing the number of independent variables, functions can be generated with which especially accurate optimal setting parameters can be calculated. The memory requirements and time expenditure during the search of functions can be reduced thereby. The so-called fitting of a characteristic diagram by one or more functions thereby permits further simplification of the on-line determination of an optimal setting parameter and a saving of time. Moreover, memory space is saved, which is available for other functions of system 1.

A third representation form is a combined form of the first representation form and the second representation form. This means that the setting parameter characteristic diagram in the third representation form in at least one parameter region is represented by a value table and in at least one other parameter region by a function table. All listed representations can be stored as such in memory 7.

In the depicted method of the invention, a pressure value is determined by measurement in the third process step 10, a rotational speed value is determined likewise by measurement in the fourth process step 11, and a target torque value is determined by specification by a user in the fifth process step 12. The user actuates a control device, e.g., a control lever, by means of which a target torque is set or established from which the torque value is determined as the target torque value.

In the later sixth process step 13, the setting parameter is determined using the pressure value, rotational speed value, target torque value, and a setting parameter characteristic diagram, which is saved in memory 7 in the first, second, or third representation form. The calculation of the first, second, or third representation form before saving as already mentioned occurs off-line. The determination of the setting parameter, in contrast, is carried out on-line, therefore during the operation of the hydrostatic system.

The setting parameter characteristic diagram, which is an inverted efficiency characteristic diagram or torque characteristic diagram, is calculated from an efficiency characteristic diagram or a torque characteristic diagram. The non-inverted efficiency characteristic diagram or torque characteristic diagram depends on at least pressure, rotational speed, and the setting parameter as input parameters or independent variables and has an efficiency or torque as the output parameter or dependent variable. In an exemplary embodiment, value tables for depicting the inverted characteristic diagrams (first representation form) are determined from non-inverted characteristic diagrams, depicted by means of value tables (first representation form), function tables (second representation form), or combinations of these (third representation form). Representations of the inverted characteristic diagrams are determined from these representations in the form of value tables (first representation form). These value tables for presenting the inverted characteristic diagrams are used to determine a first, second, or third representation form of the inverted characteristic diagrams. The determination can be carried out if necessary by one- or multidimensional interpolation. The value tables for this purpose supply the necessary support points and support values. The thus determined inverted characteristic diagrams or their representations are stored in memory 7. There they are available for on-line determination of optimal setting parameters.

A non-inverted torque characteristic diagram can be depicted by a list of measured values or for engine operation by the formulas

$${( 1 )}_{motor} {M}_{actual} ∝ {V}_{g} p {η}_{hm , motor} ( p , n , {V}_{g} )$$

$${or \\ ( 1 )}_{motor}^{*} {η ( p , n , {V}_{g} )}_{hm , motor {,}_{T . D}} ∝ \frac{{M}_{actual}}{{V}_{g} p}$$

and for pump operation by the formulas

$${( 1 )}_{pump} {M}_{actual} ∝ {V}_{g} \frac{p}{{η}_{hm , pump} ( p , n , {V}_{g} )}$$

$${or \\ ( 1 )}_{pump}^{*} \frac{1}{{η}_{hm , pump} ( p , n , {V}_{g} )} ∝ \frac{{M}_{actual}}{{V}_{g} p}$$

which takes into account the dependence of a motor or pump torque of a hydrostatic displacement unit, such as, e.g., a hydraulic motor or a hydraulic pump, on efficiency. M_{actual} here is the torque, V_{g} the pivoting angle or a parameter proportional to the pivoting angle, p the pressure, n the rotational speed, and η_{hm, motor or pump} the efficiency. The efficiency here is motor-specific and pressurizing medium-specific and can depend in addition on the operating temperature. Thus, a motor-specific, pressurizing medium-specific, and operating temperature-specific non-inverted torque characteristic diagram can be predefined. The efficiency η_{hm, motor}, moreover, depends on the pressure, rotational speed, and motor pivoting angle. The desired characteristic diagrams can be derived from characteristic diagrams calculated using the formulas, e.g., by means of the method described hereinafter.

The inverted characteristic diagrams in this case can be represented by the formula

$${( 2 )}_{motor} {V}_{g} ∝ \frac{{M}_{actual}}{p {η}_{hm , motor} ( p , n , {V}_{g} )}$$

for motor operation, or by the formula

$${( 2 )}_{pump} {V}_{g} ∝ \frac{{η}_{hm , pump} ( p , n , {V}_{g} ) {M}_{actual}}{p}$$

for pump operation.

The equation for the pivoting angle, however, cannot be solved directly, because the efficiency depends in turn on the pivoting angle and thereby the volume V_{g}. This problem can be solved either laboriously by an iterative approximation to the solution or by a search algorithm (search for the closest combinations of efficiencies and angles). It is simpler and less computationally intensive, however, to invert the characteristic diagrams even before the implementation in a control device. A requirement here is that the characteristic diagrams are strictly monotonous and one-to-one inverted characteristic diagrams can be generated thereby.

To this end, at the rotational speed level (nᵢ), the resulting torque Mₙᵢ is calculated first:

$${M}_{ni} ∝ \frac{{\vec{v}}_{g} \vec{p}}{{η}_{hm , pump} ( \vec{p} , {n}_{i} , {\vec{v}}_{g} )} \vert {n}_{i} \qquad ( 3 )$$

The pump volumes are determined by means of the transformation

T:M(\vec{p},\vec{v}_{g},\vec{n}ᵢ)→V_{g}(\vec{p},nᵢ,\vec{m}ᵢ) (4)

according to the following method:

$$\begin{matrix}{V}_{g} ( \vec{p} , {n}_{i} , {\vec{m}}_{grid} ) = interpolation 2 D ( {M}_{n} ( \vec{p} ) , {V}_{g aux} , {M}_{grid} ) \vert {n}_{i} & ( 5 ) \\ Here , {V}_{g aux} = [ \begin{matrix}{\vec{v}}_{{g}_{1}} \\ {\vec{v}}_{{g}_{j}} \\ ⋮ \\ {\vec{v}}_{{g}_{dim ( \overline{p} )}}\end{matrix} ] , {\vec{v}}_{{g}_{j }} = {\vec{v}}_{g} & ( 6 )\end{matrix}$$

and \vec{m}_{grid} as a vector of the interpolation supporting points to be established and

$${M}_{grid} = [ \begin{matrix}{\vec{m}}_{{grid}_{1}} \\ {\vec{m}}_{{grid}_{j}} \\ ⋮ \\ {\vec{m}}_{{grid}_{dim ( \overline{p} )}}\end{matrix} ] , {\vec{m}}_{{grid}_{j}} = {\vec{m}}_{grid} \qquad ( 7 )$$

Using (5) a geometric pump/motor volume matrix V_{g}(\vec{p},\vec{n}_{grid},\vec{m}_{grid}) is obtained with the basic vectors \vec{m}_{grid},\vec{p} and the rotational speed vector \vec{n}_{grid} made up of the supporting points nᵢ.

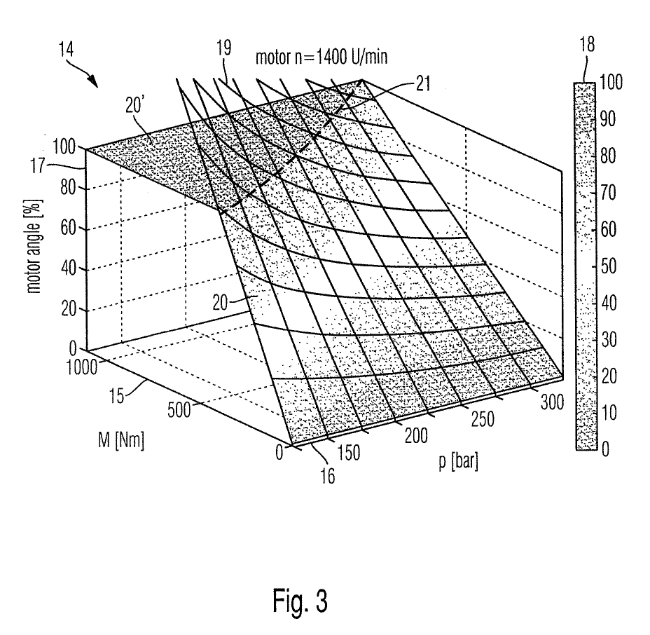

An example of a representation of a thus arising three-dimensional inverted characteristic diagram as a setting parameter characteristic diagram can be seen in FIG. 3. The relative pivoting angles as a setting parameter are not limited to 100% in the matrix, to avoid errors in the interpolation in the vicinity of the limit. As a result, a correct further off-line post-processing of the representation into another representation is possible.

The three-dimensional inverted characteristic diagram 14 has a first axis 15, a second axis 16, and a third axis 17. The first axis 15 represents a torque axis. The second axis 16 represents a pressure axis, whereas the third axis 17 represents an axis for a relative pivoting angle. The relative pivoting angle in this case is defined as the absolute pivoting angle divided by the maximum absolute pivoting angle. In the three-dimensional inverted characteristic diagram 14, a grid 21 is depicted, which shows the association between the relative pivoting angle (as a setting parameter) as a dependent variable and torque (e.g., as a target torque) and pressure as independent variables at a rotational speed value of n=1400 rpm, whereby the rotational speed is also a free variable. Another rotational speed value receives another rotational speed value-specific grid. For better recognizability of the grid values, grid 21 is highlighted by a shaded area, which divides into a first region 20 and a second region 20′. The first region 20 highlights grid 21 in the region where the grid values are below 100% of the relative pivoting angle. The second region 20′, in contrast, identifies the area under grid 21 that is characterized by the relative pivoting angle value of 100%. The first region 20 and second region 20′ intersect at edge 21. The grid area is not limited to regions with a relative pivoting angle up to at most 100%, so that errors during interpolation in the vicinity of edge 21 can be avoided. The legend 18 describes how the marking of the first region 20 depicts the associated relative pivoting angle value.

The method of the invention and the system of the invention can find use particularly in hydraulic parallel hybrid or hydraulic traction drives. Automotive driving programs can likewise use the method of the invention and/or the system of the invention. Preferably, the method of the invention and the system of the invention are used in parallel hybrid systems with a torque interface. The short on-line computing times permit a rapid, secure, and reliable control of the setting parameter.

The invention is not limited to the shown exemplary embodiments. Rather, individual features of the exemplary embodiments can also be combined advantageously.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for determining a setting parameter of a hydrostatic displacement unit, the method comprising:
determining a pressure value;
determining a rotational speed value;
determining a torque value; and
determining the setting parameter based on the pressure value, rotational speed value, torque value, and a characteristic diagram,
wherein the characteristic diagram is a setting parameter characteristic diagram, which is an inverted efficiency characteristic diagram or torque characteristic diagram, which has at least pressure, rotational speed, and torque as input parameters.

2. The method according to claim 1, wherein the setting parameter diagram is calculated off-line before the determination of the setting parameter.

3. The method according to claim 1, wherein the setting parameter characteristic diagram is stored in a memory before the determination of the setting parameter.

4. The method according to claim 1, wherein the setting parameter characteristic diagram is stored before the determination of the setting parameter at least in part as value tables.

5. The method according to claim 1, wherein the setting parameter characteristic diagram is stored before the determination of the setting parameter at least in part as a function table.

6. The method according to claim 1, wherein the pressure value and/or the rotational speed value are determined in each case from at least one measurement.

7. The method according to claim 1, wherein the torque value is predefined by a user command.

8. A system for determining a setting parameter of a hydrostatic displacement unit, the system comprising:
a system unit configured to determine a pressure value;
a system unit configured to determine a rotational speed value;
a system unit configured to determine a torque value;
a system unit configured to determine the setting parameter with use of the pressure value, rotational speed value, torque value, and a characteristic diagram,
wherein the system for determining a setting parameter is configured such that during the determination of the setting parameter, the system uses as a characteristic diagram a setting parameter characteristic diagram, which is an inverted efficiency characteristic diagram or torque characteristic diagram, which has at least pressure, rotational speed, and torque as input parameters.

9. The system according to claim 8, wherein the system for determining a setting parameter has a memory, and wherein the setting parameter diagram is storable in a memory off-line before the determination of the setting parameter.

10. The system according to claim 9, wherein the system for determining a setting parameter has a memory and wherein the setting parameter characteristic diagram is storable in a memory at least in part as a value table.

11. The system according to claim 9, wherein the setting parameter characteristic diagram is storable at least in part as a function table in a memory.

12. The system according to claim 8, wherein the system for determining a setting parameter is configured such that the pressure value and/or the rotational speed value are determined in each case from at least one measurement.

13. The system according to claim 8, wherein the system for determining a setting parameter is configured such the system unit for determining a torque value with a control device is used for specification of a torque value by a user.
